(19) United States
(12) Patent Application Publication
(10) Pub. No.: US 2011/0207038 A1
(43) Pub. Date: Aug. 25, 2011

(54) SLIPPERY SURFACE IMAGING MEMBERS

(75) Inventors: Robert C. U. Yu, Webster, NY (US); Yuhua Tong, Webster, NY (US); Stephen T. Avery, Rochester, NY (US); Jimmy E. Kelly, Rochester, NY (US)

(73) Assignee: XEROX CORPORATION, Norwalk, CT (US)

(21) Appl. No.: 12/712,064

(22) Filed: Feb. 24, 2010

(51) Int. Cl. G03G 15/00

(52) U.S. Cl. 430/56; 399/159; 430/59.6

(57) ABSTRACT

A flexible imaging member comprising a slippery charge transport layer including a novel low surface energy polymer binder and a charge transport compound in the layer. In specific embodiments, the novel low surface energy polymer binder in the charge transport layer is a bisphenol A polycarbonate containing short polysiloxane segments present in the polycarbonate backbone—thus eliminating the light scattering effect to render optical clarity—and the charge transport compound is a diamine hole transporting species. The imaging member does include an anticurl back coating to maintain flatness.

### BACKGROUND

The presently disclosed embodiments are directed to imaging members used in electrostatography. More specially, the disclosures relate to an electrostatographic imaging member having a functionally improved outermost exposed imaging layer which provides an extended useful service-life function and a process for making and using the member.

Electrostatographic imaging members are known in the art. Typical electrostatographic imaging members include (1) electrophotographic imaging members or photoreceptors for electrophotographic imaging systems and (2) electroreceptors such as ionographic imaging members for electrographic imaging systems. Generally, these imaging members comprise at least a supporting substrate and at least one imaging layer comprising a thermoplastic polymeric matrix material. In a photoreceptor, the photoconductive imaging layer may comprise only a single photoconductive layer or a plurality of layers such as a combination of a charge generating layer and one or more charge transport layer(s). In an electroreceptor, the imaging layer is a dielectric imaging layer.

Electrostatographic imaging members can have a number of distinctively different configurations. For example, they can comprise a flexible member, such as a flexible scroll or a belt containing a flexible substrate. The flexible imaging member belt may be prepared in a seamed or seamless configuration. The electrostatographic imaging member can also comprise a rigid member, such as those utilizing a rigid substrate drum. Drum imaging members have a rigid cylindrical supporting substrate bearing one or more imaging layers. Although the present disclosure is equally applicable to imaging members of any configuration, the disclosure herein after will however, for simplicity reason, focus primarily on flexible electrophotographic imaging members and only be represented by flexible seamed belts.

Flexible electrophotographic imaging member seamed belts are typically fabricated from a sheet which is cut from a web. The sheets are generally rectangular in shape. The edges may be of the same length or one pair of parallel edges may be longer than the other pair of parallel edges. The sheets are formed into a belt by joining overlapping opposite marginal end regions of the sheet. A seam is typically produced in the overlapping marginal end regions at the point of joining. Joining may be effected by any suitable means. Typical joining techniques include welding (including ultrasonic), gluing, taping, pressure heat fusing, and the like. Ultrasonic welding is generally the more desirable method of joining because it is rapid, clean (no solvents) and produces a thin and narrow seam. In addition, ultrasonic welding is more desirable because it causes generation of heat at the contiguous overlapping end marginal regions of the sheet to maximize melting of one or more layers therein to produce a strong fusion bonded seam.

A typical flexible electrophotographic imaging member belt comprises at least one photoconductive insulating layer. It is imaged by uniformly depositing an electrostatic charge on the imaging surface of the electrophotographic imaging member and then exposing the imaging member to a pattern of activating electromagnetic radiation, such as light, which selectively dissipates the charge in the illuminated areas of the imaging member while leaving behind an electrostatic latent image in the non-illuminated areas. This electrostatic latent image may then be developed to form a visible image by depositing finely divided electroscopic marking toner particles on the imaging member surface. The resulting visible toner image can then be transferred to a suitable receiving member or substrate such as paper.

A number of current flexible electrophotographic imaging members are multilayered photoreceptor belts that, in a negative charging system, comprise a substrate support, an electrically conductive layer, an optional charge blocking layer, an optional adhesive layer, a charge generating layer (CGL), a charge transport layer (CTL), and an optional anti-curl back coating at the opposite side of the substrate support. In such an electrophotographic imaging member design, the CTL is the outermost layer and is exposed to the environment. Since flexible electrophotographic imaging members exhibit upward curling after completing the application process of a CTL, an anti-curl back coating is usually employed on the back side of the flexible substrate support (the side opposite from the electrically active layers) to balance/control the curl and render the imaging member with desired flatness.

In a typical machine design, a flexible imaging member belt is mounted over and around a belt support module comprising numbers of belt support rollers, such that the top outermost CTL is exposed to all electrophotographic imaging subsystems interactions. Under normal operating conditions, the top exposed CTL surface of the flexible imaging member belt is constantly subjected to physical/mechanical/electrical/chemical species interactions such as the mechanical sliding actions of cleaning blade and cleaning brush, electrical charging devices, corona effluents exposure, developer components, image formation toner particles, hard carrier particles, receiving paper, and the like during dynamic belt cyclic motion. These interactions, particularly the friction force arisen by the sliding action of cleaning blade/brush/tab blade, against the surface of the CTL have been found to cause surface scratching, abrasion, and rapid CTL surface wear; in some instances, the CTL wears away by as much as 10 micrometers after approximately 20,000 dynamic belt imaging cycles. Excessive CTL wear is a serious problem because it causes significant change in the charged field potential and adversely impacts copy printout quality. Another consequence of CTL wear is the decrease of CTL thickness alters the equilibrium of the balancing forces between the CTL and the anti-curl back coating and impacts imaging member belt flatness. The reduction of the CTL by wear causes the imaging member belt to curl downward at both edges. Edge curling in the belt is an important issue because it changes the distance between the belt surface and the charging device(s), causing non-uniform surface charging density which manifests itself as a “smile” print defect on paper copies. Such a print defect is characterized by lower intensity of print-images at the locations over both belt edges. The susceptibility of the CTL surface to scratches (caused by interaction against developer carrier beads and hard particulate from paper debris) has also been identified as a major imaging member functional failure since the scratches manifest themselves as print defects.

In a rigid electrophotographic imaging member drum design utilizing a contact AC Bias Charging Roller (BCR), ozone species attack on the CTL polymer binder is more pronounced because of the close vicinity of the BCR to the CTL of the imaging member drum. Therefore CTL wear by cleaning blade/brush/tab blade mechanical interaction is exacerbated and becomes more pronounced as a result of polymer binder degradation caused by ozone attack.

To provide desirable photo-electrical activity function, the current CTL (having a high surface energy of about 39 dynes/cm) is formulated with material compositions that are needed to give proper xerographic function. The high surface energy CTL is therefore prone to collect toner residues, dirt/debris particles, and additives from receiving papers. The eventual fusion of these collected species causes the formation of comets and filming over the outer surface of the CTL, further degrading the image quality of printouts. Another problem associated with high CTL surface energy is that it produces high sliding contact friction against the cleaning blade, tab blade, and cleaning brush mechanical action to exacerbate abrasion and wear failures. Moreover, since high CTL surface energy does also impede absolute toner image transfer from imaging member surface to the receiving paper, it is therefore impacting the image quality of printout copies.

Therefore, there is an urgent need for preparation of imaging members which exhibit little or non of the abovementioned shortfalls and provide good abrasion/wear/filming resistances, surface slipperiness/lubricity, and mechanical durability. Because such imaging members shall effect physical/mechanical function enhancements to significantly impact the imaging members service life extension in the field.

The disclosures of the following patents are hereby incorporated in their entireties by reference.

U.S. Pat. No. 7,611,811 discloses a negatively charged electrophotographic imaging member consisting of a flexible supporting substrate with an electrically conductive outer surface, a CGL, and at least a one outermost exposed CTL layer comprises of a polycarbonate binder, a charge transport compound, and a low surface energy film forming polymer containing short chain polysiloxane segments in its backbone. The prepared imaging member has low surface energy surface, reduced surface contact friction, and improved surface lubricity.

U.S. Pat. No. 6,117,603 discloses an electrophotographic imaging member including a supporting substrate having an electrically conductive outer surface and at least a one layer having an exposed imaging surface, the CTL, including a continuous matrix comprising a film forming polymer and a surface energy lowering liquid polysiloxane.

U.S. Pat. No. 6,326,111 relates to a charge transport material for a photoreceptor including at least a polycarbonate polymer, at least one charge transport material, polytetrafluoroethylene (PTFE) particle aggregates having an average size of less than about 1.5 microns, hydrophobic silica and a fluorine-containing polymeric surfactant dispersed in a solvent. The presence of the hydrophobic silica enables the dispersion to have superior stability by preventing settling of the PTFE particles. A resulting CTL produced from the dispersion exhibits excellent wear resistance against contact with an AC bias charging roll, excellent electrical performance, and delivers superior print quality.

U.S. Pat. No. 6,337,166 discloses a charge transport material for a photoreceptor including at least a polycarbonate polymer binder having a number average molecular weight of not less than 35,000, at least one charge transport material, polytetrafluoroethylene (PTFE) particle aggregates having an average size of less than about 1.5 microns, and a fluorine-containing polymeric surfactant dispersed in a solvent mixture of at least tetrahydrofuran and toluene. The dispersion is able to form a uniform and stable material ideal for use in forming a CTL of a photoreceptor. The resulting CTL exhibits excellent wear resistance against contact with an AC bias charging roll, excellent electrical performance, and delivers superior print quality.

U.S. Pat. No. 4,265,990 illustrates a layered photoreceptor having a separate charge generating layer and a separate CTL. The charge generating layer is capable of photogenerating holes and injecting the photogenerated holes into the CTL. The photogenerating layer utilized in multilayered photoreceptors includes, for example, inorganic photoconductive particles or organic photoconductive particles dispersed in a film forming polymeric binder. Examples of photosensitive members having at least two electrically operative layers including a charge generating layer and a diamine containing transport layer are disclosed in U.S. Pat. Nos. 4,233,384; 4,306,008; 4,299,897; and, 4,439,507, the disclosures of each of these patents being totally incorporated herein by reference in their entirety.

U.S. Pat. No. 5,096,795 discloses the preparation of a multilayered photoreceptor containing particulate materials for the exposed layers in which the particles are homogeneously dispersed therein. The particles reduce the coefficient of surface contact friction, increase wear resistance and durability against tensile cracking, and improve adhesion of the layers without adversely affecting the optical and electrical properties of the resulting photoreceptor.

In U.S. Pat. No. 5,069,993 issued to Robinette et al on Dec. 3, 1991, an exposed layer in an electrophotographic imaging member is provided with increased resistance to stress cracking and reduced coefficient of surface friction, without adverse effects on optical clarity and electrical performance. The layer contains a polymethylsiloxane copolymer and an inactive film forming resin binder.

U.S. Pat. No. 5,830,614 relates to a charge transport having two layers for use in a multilayer photoreceptor. The photoreceptor comprises a support layer, a charge generating layer, and two CTLs. The CTLs consist of a first transport layer comprising a charge transporting polymer (consisting of a polymer segment in direct linkage to a charge transporting segment) and a second transport layer comprising a same charge transporting polymer except that it has a lower weight percent of charge transporting segment than that of the first CTL. In the '614 patent, the hole transport compound is connected to the polymer backbone to create a single giant molecule of hole transporting polymer.

Although the prior arts of all the above disclosures electrophotographic imaging members comprising a supporting substrate, a conductive surface on one side, coated over with at least one photoconductive layer (such as the outermost CTL), and coated on the other side of the supporting substrate with an anticurl back coating have offer some degree of improvements, but do still exhibit deficiencies which are undesirable in advanced automatic, cyclic electrophotographic imaging copiers, duplicators, and printers. While the above mentioned electrophotographic imaging members may be suitable or limited for their intended purposes, further improvement on these imaging members are definitively required. For example, there continues to be the need for improvements in such systems, particularly for an imaging member belt that reduces the CTL surface friction, improves wear resistance, provides lubricity to ease cleanly, minimizes wear debris build-up, and enhances toner image transfer efficiency to receiving papers with improved image print-out quality in printing apparatuses/machines. In the present disclosure, a CTL material comprising an improved low surface energy polymer to impart CTL surface lubrication has been prepared and demonstrated. This is achieved through the incorporation of a novel low surface energy polycarbonate in the CTL by CTL re-formulation. The resulting imaging member has provided effective surface slipperiness to effect contact friction reduction and abhesiveness for toner image paper transfer efficiency enhancement.

### SUMMARY

According to aspects illustrated herein, there is provided a flexible imaging member comprising a flexible substrate, a charge generating layer disposed on the substrate, and at least one charge transport layer disposed on the charge generating layer, wherein the charge transport layer comprises a charge transport component molecularly dispersed in a low surface energy polycarbonate binder, the polymer binder being an A-B di-block copolymer comprising two segmental blocks, the first segment block (A) being

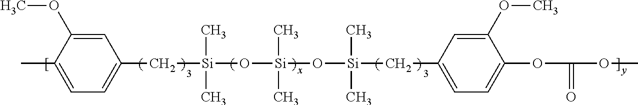

wherein x is 10 to 40, y is 1 to 15, and the second segment block (B) being selected from the group consisting of

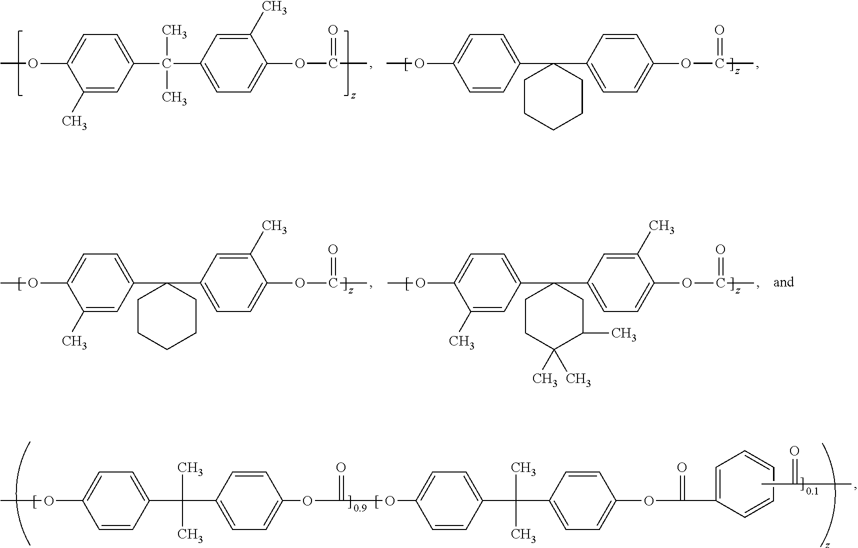

wherein z is 50 to 400.

In further embodiments, there is provided a flexible imaging member comprising a flexible substrate, a charge generating layer disposed on the substrate, a bottom charge transport layer disposed on the charge generating layer, and a top exposed charge transport layer disposed on the bottom charge transport layer, wherein the top exposed charge transport layer comprises a charge transport component molecularly dispersed in a low surface energy polycarbonate binder, the polymer binder being formed from a modified Bisphenol A polycarbonate poly(4,4′-isopropylidene diphenyl carbonate) having from about 4 percent to about 8 percent by weight of polydimethyl siloxane containing segments present in the low surface energy polycarbonate back bone and having the following molecular formula:

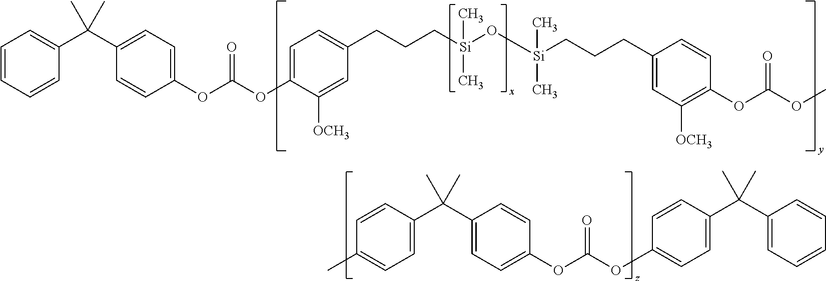

wherein x is 10 to 40, y is 1 to 15, and z is 50 to 400.

In yet further embodiments, there is provided an image forming apparatus for forming images on a recording medium comprising a) a flexible imaging member having a charge retentive-surface for receiving an electrostatic latent image thereon, wherein the flexible imaging member comprises a flexible substrate, a charge generating layer disposed on the substrate, and at least one charge transport layer disposed on the charge generating layer, wherein the charge transport layer comprises a charge transport component molecularly dispersed in a low surface energy polycarbonate binder, the polymer binder being an A-B di-block copolymer comprising two segmental blocks, the first segment block (A) being

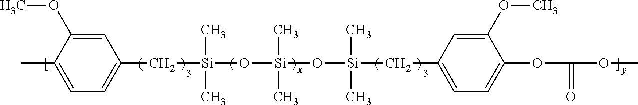

wherein x is 10 to 40, y is 1 to 15, and the second segment block (B) being selected from the group consisting of

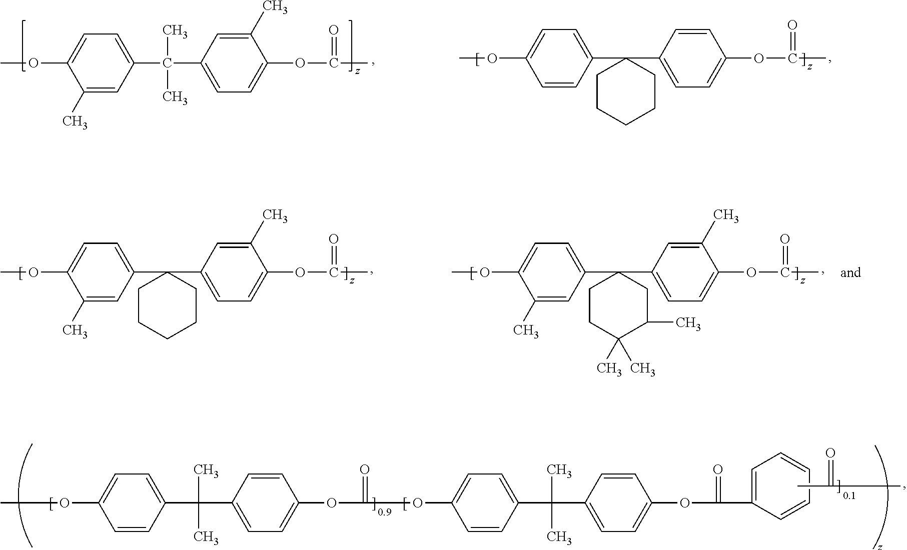

wherein z is 50 to 400, b) a development component for applying a developer material to the charge-retentive surface to develop the electrostatic latent image to form a developed image on the charge-retentive surface, c) a transfer component for transferring the developed image from the charge-retentive surface to a copy substrate, and d) a fusing component for fusing the developed image to the copy substrate.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a schematic cross-sectional view of an exemplary embodiment of an imaging member having a single layer CTL;

FIG. 2 is a schematic cross-sectional view of another exemplary embodiment in which the imaging member contains a dual-layer CTL;

FIG. 3 is a schematic cross-sectional view of a third exemplary embodiment in which the imaging member comprises a multiple-layer CTL;

FIG. 4 is a graphic presentation illustrating the photo-induced discharge characteristics curves of an exemplary embodiment imaging member, prepared according to a prior art; and

FIG. 5 is a graphic presentation illustrating the photo-induced discharge characteristics curves of an exemplary embodiment imaging member, prepared according to the present disclosure.

### DETAILED DESCRIPTION

There are disclosed at present, in various exemplary embodiments, processes and compositions for extending the functional life of an electrophotographic imaging member through charge transport layer (CTL) re-formulation. These processes and compositions relate generally to a mechanically robust CTL designed to produce low surface energy slippery surface, which renders abrasion/scratch/wear resistance and less propensity to develop surface filming, to thereby extend the imaging member service life under normal machine functioning conditions.

In one embodiment, a flexible imaging member has a re-formulated CTL comprising a novel low surface energy polymer binder and a charge transport compound. In specific embodiments, the novel low surface energy polymer binder in the CTL is a bisphenol A polycarbonate containing short polysiloxane segments present in polycarbonate backbone and the charge transport compound is a diamine hole transporting species.

In another embodiment, the CTL is comprised of the novel low surface energy polymer binder, a compatible film forming polymer binder, and a charge transport compound.

In yet another embodiment, the CTL is dual-layered design having a top exposed layer and a bottom layer in contiguous contact with the CGL. The top exposed layer comprises the novel low surface energy polymer binder and a charge transport compound, whereas the bottom layer comprises a film forming polymer binder (different from the low surface energy polymer) and a charge transport compound of the same concentration as that in the top exposed layer. In a modification of this embodiment, the top exposed layer comprises a polymer blend binder consisting of the low surface energy polymer and a film forming polymer (the same or different from the bottom layer), and a charge transport compound. In further modifications of these two embodiments, the top exposed layer comprises less amount of charge transport compound than that in the bottom layer.

In an alternative embodiment, the CTL is multi-layered design comprises a plurality of layers. In the multi-layered CTL comprising polymer blend binder of the low surface energy polymer and the film forming polymer, the amount of low surface energy polymer blended with the film forming polymer binder is present in an ascending order that is increased in each layer starting from the bottom layer to reach a maximum at the top outermost exposed layer. But in contrast, the concentration of the charge transport compound is present in descending order that decreases from the top exposed layer and reaches a maximum at the bottom layer. In a modification of the alternative embodiment having the multi-layered CTL, the top exposed layer of the plurality of layers comprises only the low surface energy polymer binder and the charge transport compound and without inclusion of the film forming polymer.

Processes for making an imaging member having the CTL of the present disclosure are also provided.

These and other non-limiting features and characteristics of the exemplary embodiments of the present disclosure are described below.

The flexible imaging members prepared to have improved low surface energy CTL formulation according to the descriptions detailed in the present disclosed development can be used in a number of different known imaging and printing processes including, for example, electrophotographic imaging processes, especially xerographic imaging and printing processes wherein charged latent images are rendered visible with toner compositions of an appropriate charge polarity. Moreover, the imaging members of this disclosure are also useful in color xerographic applications, particularly high-speed color copying and printing processes. In these applications, the imaging members are in embodiments sensitive in the wavelength region of from about 500 to about 900 nanometers, and in particular from about 650 to about 850 nanometers; thus, diode lasers can be selected as the light source.

The exemplary embodiments of this disclosure are more particularly described below with reference to the drawings. Although specific terms are used in the following description for clarity, these terms are intended to refer only to the particular structure of the various embodiments selected for illustration in the drawings and not to define or limit the scope of the disclosure. The same reference numerals are used to identify the same structure in different Figures unless specified otherwise. The structures in the figures are not drawn according to their relative proportions and the drawings should not be interpreted as limiting the disclosure in size, relative size, or location. In addition, though the discussion will address negatively charged systems, the imaging members of the present disclosure may also be used in positively charged systems.

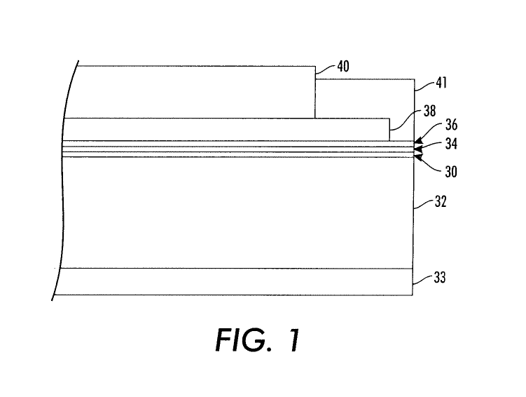

The flexible imaging member embodiment comprising a single layered charge transport layer (CTL) is illustrated in FIG. 1. The substrate 32 has an optional conductive layer 30. An optional hole blocking layer 34 can also be applied, as well as an optional adhesive layer 36. The charge generating layer (CGL) 38 is located above the 32/30/34/36 layers and below the CTL 40. An optional ground strip layer 41 operatively connects the charge generating layer 38 and the CTL 40 to the conductive layer 30. An anti-curl back layer 33 is applied to the side of the substrate 32 opposite from the electrically active layers to render the imaging member flat.

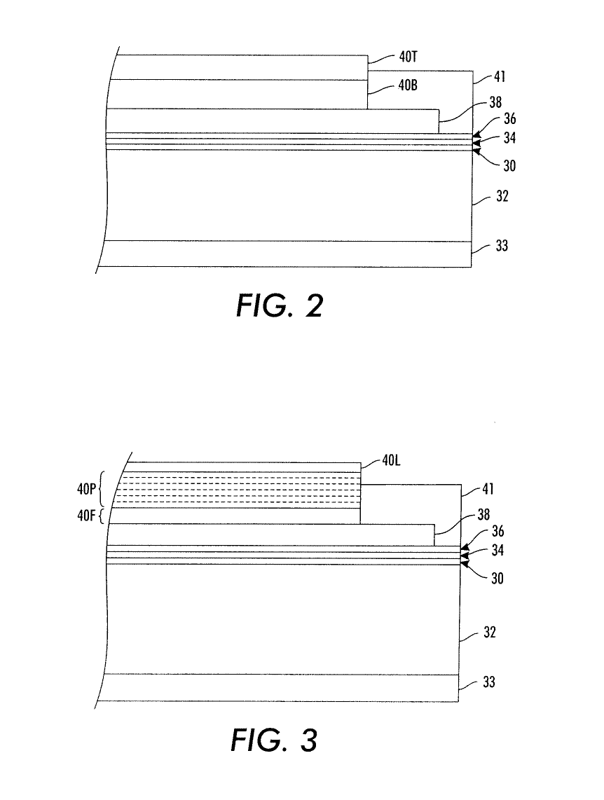

In another flexible imaging member embodiment shown in FIG. 2, the CTL is comprised of dual charge transport layers 40B and 40T. The dual layers 40B and 40T may have the same or different compositions.

In an alternative flexible imaging member embodiment illustrated in FIG. 3, the CTL formed to comprised of multi-layered design having plurality of layers; that includes a first (or bottom) charge transport layer 40F in contiguous contact with CGL, one or more intermediate charge transport layers 40P, and a last or outermost charge transport layer 40L at the very top. Each layer 40P may have the same or different composition as the other layers, but the outermost charge transport layer 40L has the lowest surface energy. Since the CTL in these three figures is the outermost layer of the imaging member, it is therefore exposed to the operating environment of the machine.

In reference to the exemplary embodiment of FIG. 1, the substrate 32 provides support for all layers of the imaging member. Its thickness depends on numerous factors, including mechanical strength, flexibility, and economical considerations; the substrate for a flexible belt may, for example, be from about 50 micrometers to about 150 micrometers thick, provided there are no adverse effects on the final electrophotographic imaging device. The substrate support is not soluble in any of the solvents used in each coating layer solution, is optically transparent, and is thermally stable up to a high temperature of about 150° C. A typical substrate support is a biaxially oriented polyethylene terephthalate. Another suitable substrate material is a biaxially oriented polyethylene naphtahlate, having a thermal contraction coefficient ranging from about 1×10⁻⁵/° C. to about 3×10⁻⁵/° C. and a Young's Modulus of from about 5×10⁵ psi to about 7×10⁵ psi. However, other polymers are suitable for use as substrate supports. The substrate support may also be made of a conductive material, such as aluminum, chromium, nickel, brass and the like. Again, the substrate support may flexible or rigid, seamed or seamless, and have any configuration, such as a plate, drum, scroll, belt, and the like.

The optional conductive layer 30 is present when the substrate is not itself conductive. It may vary in thickness depending on the optical transparency and flexibility desired for the electrophotographic imaging member. Accordingly, when a flexible electrophotographic imaging belt is desired, the thickness of the conductive layer may be from about 20 angstroms to about 750 angstroms, and more specifically from about 50 angstroms to about 200 angstroms for an optimum combination of electrical conductivity, flexibility and light transmission. The conductive layer may be formed on the substrate by any suitable coating technique, such as a vacuum depositing or sputtering technique. Typical metals suitable for use as the conductive layer include aluminum, zirconium, niobium, tantalum, vanadium, hafnium, titanium, nickel, stainless steel, chromium, tungsten, molybdenum, and the like.

The optional hole blocking layer 34 forms an effective barrier to hole injection from the adjacent conductive layer into the charge generating layer. Examples of hole blocking layer materials include gamma amino propyl triethoxyl silane, zinc oxide, titanium oxide, silica, polyvinyl butyral, phenolic resins, and the like. Hole blocking layers of nitrogen containing siloxanes or nitrogen containing titanium compounds are disclosed, for example, in U.S. Pat. No. 4,291,110, U.S. Pat. No. 4,338,387, U.S. Pat. No. 4,286,033 and U.S. Pat. No. 4,291,110, the disclosures of these patents being incorporated herein in their entirety. The blocking layer may be applied by any suitable conventional technique such as spraying, dip coating, draw bar coating, gravure coating, silk screening, air knife coating, reverse roll coating, vacuum deposition, chemical treatment and the like. The blocking layer should be continuous and more specifically have a thickness of from about 0.2 to about 2 micrometers.

An optional adhesive layer 36 may be applied to the hole blocking layer. Any suitable adhesive layer may be utilized. One well known adhesive layer includes a linear saturated copolyester consists of alternating monomer units of ethylene glycol and four randomly sequenced diacids in a ratio of four diacid units to one ethylene glycol unit and has a weight average molecular weight of about 70,000 and a T˜ of about 32° C. If desired, the adhesive layer may include a copolyester resin. The adhesive layer including the polyester resin is applied to the blocking layer. Any adhesive layer employed should be continuous and, more specifically, have a dry thickness from about 200 micrometers to about 900 micrometers and, even more specifically, from about 400 micrometers to about 700 micrometers. Any suitable solvent or solvent mixtures may be employed to form a coating solution of the polyester. Typical solvents include tetrahydrofuran, toluene, methylene chloride, cyclohexanone, and the like, and mixtures thereof. Any other suitable and conventional technique may be used to mix and thereafter apply the adhesive layer coating mixture to the hole blocking layer. Typical application techniques include spraying, dip coating, roll coating, wire wound rod coating, and the like. Drying of the deposited coating may be effected by any suitable conventional technique such as oven drying, infra red radiation drying, air drying, and the like.

Any suitable CGL 38 may be applied which can thereafter be coated over with a contiguous CTL. The charge generating layer generally comprises a charge generating material and a film-forming polymer binder resin. Charge generating materials such as vanadyl phthalocyanine, metal free phthalocyanine, benzimidazole perylene, amorphous selenium, trigonal selenium, selenium alloys such as selenium-tellurium, selenium-tellurium-arsenic, selenium arsenide, and the like and mixtures thereof may be appropriate because of their sensitivity to white light. Vanadyl phthalocyanine, metal free phthalocyanine and tellurium alloys are also useful because these materials provide the additional benefit of being sensitive to infrared light. Other charge generating materials include quinacridones, dibromo anthanthrone pigments, benzimidazole perylene, substituted 2,4-diamino-triazines, polynuclear aromatic quinones, and the like. Benzimidazole perylene compositions are well known and described, for example, in U.S. Pat. No. 4,587,189, the entire disclosure thereof being incorporated herein by reference. Other suitable charge generating materials known in the art may also be utilized, if desired. The charge generating materials selected should be sensitive to activating radiation having a wavelength from about 600 to about 700 nm during the imagewise radiation exposure step in an electrophotographic imaging process to form an electrostatic latent image.

Any suitable inactive film forming polymeric material may be employed as the binder in the charge generating layer, including those described, for example, in U.S. Pat. No. 3,121,006, the entire disclosure thereof being incorporated herein by reference. Typical organic polymer binders include thermoplastic and thermosetting resins such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, and the like.

The charge generating material can be present in the polymer binder composition in various amounts. Generally, from about 5 to about 90 percent by volume of the charge generating material is dispersed in about 10 to about 95 percent by volume of the polymer binder, and more specifically from about 20 to about 30 percent by volume of the charge generating material is dispersed in about 70 to about 80 percent by volume of the polymer binder.

The CGL 38 generally ranges in thickness of from about 0.1 micrometer to about 5 micrometers, and more specifically has a thickness of from about 0.3 micrometer to about 3 micrometers. The charge generating layer thickness is related to binder content. Higher polymer binder content compositions generally require thicker layers for charge generation. Thickness outside these ranges can be selected in order to provide sufficient charge generation.

An optional anti-curl back coating 33 can be applied to the back side of the substrate (the side opposite the side bearing the electrically active coating layers) in order to render the imaging member flat. Although the anti-curl back coating may include any electrically insulating or slightly semi-conductive organic film forming polymer, it is usually the same polymer as used in the CTL polymer binder. An anti-curl back coating from about 7 to about 30 micrometers in thickness is found to be adequately sufficient for balancing the curl and render imaging member flatness.

An electrophotographic imaging member may also include an optional ground strip layer 41. The ground strip layer comprises, for example, conductive particles dispersed in a film forming binder and may be applied to one edge of the photoreceptor to operatively connect the CTL 40, charge generating layer 38, and conductive layer 30 for electrical continuity during electrophotographic imaging process. The ground strip layer may comprise any suitable film forming polymer binder and electrically conductive particles. Typical ground strip materials include those enumerated in U.S. Pat. No. 4,664,995, the entire disclosure of which is incorporated by reference herein. The ground strip layer may have a thickness from about 7 micrometers to about 42 micrometers, and more specifically from about 14 micrometers to about 23 micrometers.

The CTL 40 may comprise any material capable of supporting the injection of photogenerated holes or electrons from the charge generating layer and allowing their transport holes through the CTL to selectively discharge the surface charge on the imaging member surface. The CTL, in conjunction with the CGL, should also be an insulator to the extent that an electrostatic charge placed on the CTL is not conducted in the absence of illumination. It should also exhibit negligible, if any, discharge when exposed to a wavelength of light useful in xerography, e.g., about 4000 angstroms to about 9000 angstroms. This ensures that when the imaging member is exposed, most of the incident radiation is used in the charge generating layer to efficiently produce photogenerated holes.

The CTL of present disclosure comprises a novel low surface energy film forming polycarbonate binder and a charge transport compound to support the injection and transport of photogenerated holes or electrons. In another embodiment, the CTL comprises a charge transport compound and a binder of polymer blend comprising of the novel film forming low surface energy polycarbonate and a compatible film forming polymer. Typical film forming polymer candidates suitable to blend with the novel low surface energy polycarbonate are polycarbonates having a weight average molecular weight Mw of from about 20,000 to about 250,000. Polycarbonates having a Mw of from about 50,000 to about 120,000 are suitable for forming a coating solution having proper viscosity for easy CTL application. When the CTL is formulated to have the disclosed polymer blended binder, electrically inactive polycarbonate resins suitable for use in the polymer blend may include poly(4,4′-dipropylidene-diphenylene carbonate) with a weight average molecular weight (Mw) of from about 35,000 to about 40,000, available as LEXAN 145 from General Electric Company; poly(4,4′-isopropylidene-diphenylene carbonate) with a molecular weight of from about 40,000 to about 45,000, available as LEXAN 141 from the General Electric Company; and a polycarbonate resin having a molecular weight of from about 20,000 to about 50,000 available as MERLON from Mobay Chemical Company.

In one specific embodiment, the film-forming polymer is a bisphenol A polycarbonate of poly(4,4′-isopropylidene diphenyl) carbonate known as MAKROLON, available from Mobay Chemical Company (or FPC0170, available from Mitsubishi Chemicals), and having a molecular weight of from about 130,000 to about 200,000. The molecular structure of MAKROLON is given in Formula (1) below:

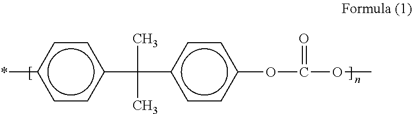

where n indicates the degree of polymerization.

In another specific embodiment, the film-forming polycarbonate is poly(4,4′-diphenyl-1,1′-cyclohexane) carbonate. The molecular structure of poly(4,4′-diphenyl-1,1′-cyclohexane) carbonate, having a M, of about between about 20,000 and about 200,000, is given in Formula (2) below:

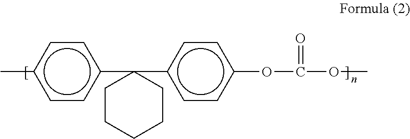

where n indicates the degree of polymerization.

In one embodiment, the novel film forming low surface energy polycarbonate viable for present disclosure application is, in particular, derived and modified from a bisphenol A polycarbonate to include short chain poly(dimethylsiloxane) (PDMS) segments homogeneously inserted in the backbone of the polymer chain. Therefore, the resulting low surface energy polycarbonate is an A-B di-block copolymer consisting of polycarbonate with PDMS segments present in the backbone to render its surface lubricity and abhesiveness. The novel low surface energy polycarbonate, if incorporated into the CTL formulation, should be able to effectively reduce the surface energy of the layer to impact surface contact friction reduction of the CTL of this disclosure; so, it becomes a slippery CTL.

The particular low surface energy polycarbonates of the present disclosure are described in the following paragraphs. The low surface energy bisphenol A polycarbonate that is derived/modified from bisphenol A polycarbonate to include PDMS segments in the main polycarbonate chain backbone. It is now a commercially available product as LEXAN EXL1463C from Sabic Plastics. As a matter of fact, LEXAN EXL1463C polycarbonate is an improved version of the LEXAN EXL 1414T polycarbonate disclosed in the prior art. Therefore both low surface energy polymers are, by definition, A-B di-block copolymer having same molecular structure which comprise two segmental blocks—that is a PDMS containing block (A) and a bisphenol A block (B) polycarbonate backbone shown below:

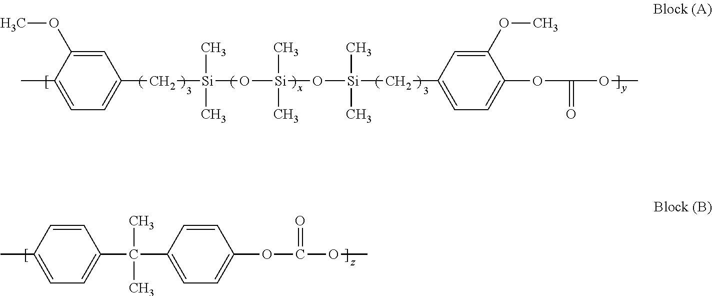

wherein x is the number of dimethyl siloxane (DMS) repeat units, ranging from about 10 to about 40 (specifically about 26) for EXL1463C and from 40 to 70 (specifically about 50) for EXL 1414T; y is number of PDMS containing block (A) segment repeats of between 1 and 15 calculated based on between about 4 and about 8 weight percent of the molecular weight of the low surface energy polycarbonate; and z is the degree of polymerization of the main chain bisphenol A polycarbonate of poly(4,4′-isopropylidene diphenyl carbonate) in Block (B) determined from the molecular weight of the low surface energy polycarbonate of from about 15,000 to about 130,000 to give values of from 50 to 400. The di-block copolymer structure of the novel low surface energy bisphenol A polycarbonate can therefore be generally represented by Formula (1) below:

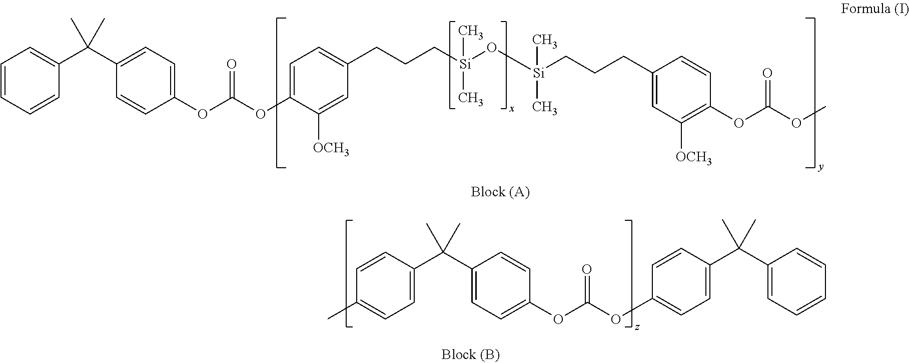

The low surface energy polycarbonate used for CTL re-formulation should have a molecular weight of at least 15,000 but is preferably to be between 20,000 and 130,000 from solubility and viscosity consideration. Although both LEXAN EXL1463C and LEXAN EXL1414T low surface energy polycarbonates contain about same amount of PDMS containing block (A) segment (that is between about 2 to about 10 weight percent based on the total molecular weight of the low surface energy polycarbonate) in the backbone of the bisphenol A polycarbonate main chain block (B), but with the exception that the block (A) segment in the LEXAN EXL1463C polycarbonate chain is particularly designed to have a lesser number of PDMS repeating units x (or shorter PDMS chain length) than those in the LEXAN EXL1414T polycarbonate of prior art disclosure in order to eliminate the light scattering effect. With this specific feature in the novel low surface energy polycarbonate, the coating layer obtained for EXL 1463C is therefore optically clear compared to the haziness seen for the EXL1414T coating counterpart.

From optics point of view, the observed haziness in the EXL1414T coating layer is due to the fact that refractive index mismatch, existing between PDMS segments and polycarbonate main chain, is the root cause of light scattering problem. Therefore, by shortening the PDMS chain length (intentionally designed to have less repeating units) in the low surface energy EXL1463C polycarbonate, the light scattering is thus effectively eliminated to give optically clear coating layer. The relationship of refractive index mismatch and particle size impact on light scattering effect has been demonstrated by one analogous experimental example established in our lab. In essence, when a polycarbonate coating is prepared to contain 5 weight percent micron-size silica dispersion in its material matrix, the resulting layer was hazy; but by comparison, when another polycarbonate coating layer is prepared through same manner, except with 5 weight percent nano-size silica dispersion, the layer obtained is clear.

In the further embodiments, the novel low surface energy polycarbonate for use in reformulating the CTL of this disclosure can alternatively be one of the several variances that are conveniently derived/obtained through the modification of block (B) segment of the polycarbonate main chain of Formula (1) to give further structures, as shown below.

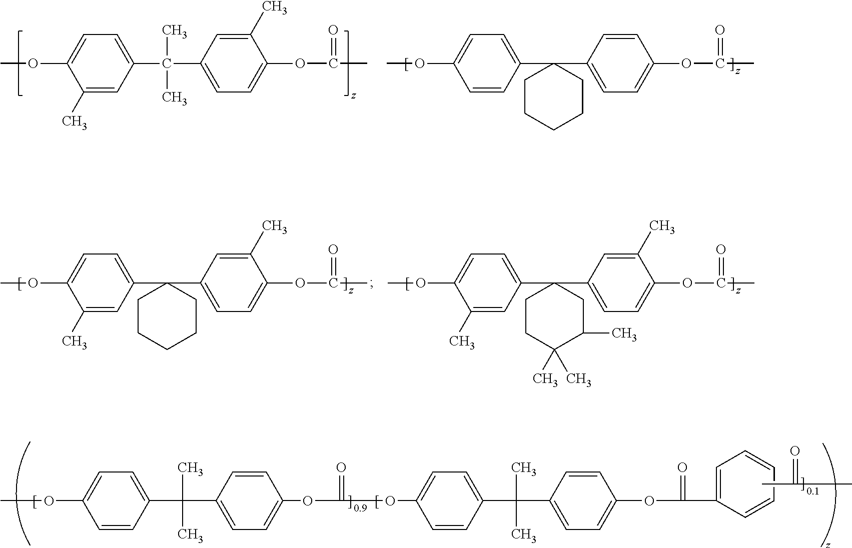

All the low surface energy polycarbonates described in the precedence should contain dimethyl siloxane (DMS), having x repeating units not to exceed 40, to impact reasonable coating layer light transmission. However, it is preferred to be in a range of between about 10 and about 40 to produce satisfactory light transparency; and at specifically about 26, the coating layer has absolute optical clarity. For the amount of PDMS containing block (A) segments present in the main polycarbonate backbone chain of block (B), it is between about 2 and about 10 weight percent based on the total weight of the low surface energy polycarbonate. In specific embodiments, the low surface energy polycarbonate contains from about 4 to about 6 weight percent of PDMS containing block (A) segments. The low surface energy polymer has a molecular weight from about 20,000 to about 200,000. In specific embodiments, it has a molecular weight from about 25,000 to about 130,000 to effect solvent solubility and good coating solution viscosity control for proper imaging layer coating application. Since the presence of PDMS containing block (A) in the polycarbonate backbone do reduce the surface energy of the reformulated CTL, it thereby increases the surface lubricity/abhesiveness to impact surface contact friction reduction.

Examples of charge transport compounds used in the CTL include, but are not limited to, triphenylmethane; bis(4-diethylamine-2-methylphenyl)phenylmethane; stilbene; hydrazone; an aromatic amine comprising tritolylamine; arylamine; enamine phenanthrene diamine; N,N′-bis(4-methylphenyl)-N,N′-bis[4-(1-butyl)-phenyl]-[p-terphenyl]-4,4′-diamine; N,N′-bis(3-methylphenyl)-N,N′-bis[4-(1-butyl)-phenyl]-[p-terphenyl]-4,4′-diamine; N,N′-bis(4-t-butylphenyl)-N,N′-bis[4-(1-butyl)-phenyl]-[p-terphenyl]-4,4′-diamine; N,N,N′,N′-tetra[4-(1-butyl)-phenyl]-[p-terphenyl]-4,4′-diamine, N,N,N′,N′-tetra[4-t-butyl-phenyl]-[p-terphenyl]-4,4′-diamine; N,N′-diphenyl-N,N′-bis(4-methylphenyl)-1,1′-biphenyl-4,4′-diamine; N,N′-bis(4-methylphenyl)-N,N′-bis(4-ethylphenyl)-1,1′-(3,3′-dimethylbiphenyl)-4,4′-diamine; 4,4′-bis(diethylamino)-2,2′-dimethyltriphenylmethane; N,N′-diphenyl-N,N′-bis(3-methylphenyl)-[1,1′-biphenyl]-4,4′-diamine; N,N′-diphenyl-N,N′-bis(alkylphenyl)-1,1′-biphenyl-4,4′-diamine; and N,N′-diphenyl-N,N′-bis(chlorophenyl)-1,1′-biphenyl-4,4′-diamine. Combinations of different charge compounds are also contemplated so long as they are present in an effective amount. In further embodiments, the charge transport compound is a diamine represented by the molecular structure below:

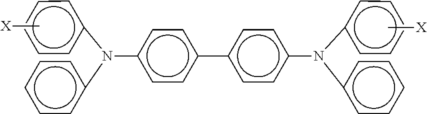

wherein X is selected from the group consisting of alkyl, hydroxy, and halogen. Such diamines are disclosed in U.S. Pat. No. 4,265,990, U.S. Pat. No. 4,233,384, U.S. Pat. No. 4,306,008, U.S. Pat. No. 4,299,897 and U.S. Pat. No. 4,439,507; these disclosures are herein incorporated in their entirety for reference.

The charge transport compound may comprise from about 10 to about 90 weight percent of the CTL, based on the total weight of the CTL. In an exemplary embodiment, the charge transport compound comprises from about 35 to about 75 weight percent or from about 60 to about 70 weight percent of the CTL for optimum function. Typically, the CTL has a thickness of from about 10 to about 40 micrometers. It may also have a Young's Modulus in the range of from about 3.0×10⁵ psi to about 4.5×10⁵ psi, a thermal contraction coefficient of from about 6×10⁻⁵/° C. to about 8×10⁻⁵/° C., and/or a glass transition temperature Tg of from about 75° C. to about 100° C. In some embodiments, the CTL has all of these properties.

In the embodiments where the CTL comprises dual or multiple layers, as those illustrated in FIGS. 2 and 3, the first layer (40B and 40F, respectively) is typically comprised of a film forming polymer binder, such as a polycarbonate, and a charge transport compound. However, the CTL may alternatively comprise of triple layers (not shown) consisting of first or bottom layer typically of film forming polycarbonate binder, a middle layer of film forming polycarbonate binder, and a top exposed layer of a low surface energy polycarbonate or a blended binder of the low surface energy polycarbonate and the film forming polycarbonate to impact surface slipperiness. In the triple CTL layers, the charge transport compound is present in the descending order that decreases from the maximum concentration at the bottom layer and reaches the minimum concentration at top exposed layer.

Referring to FIGS. 2 and 3, the next layer (40T and plurality of layers 40P, respectively) is then comprised of a charge transport compound and a polymer blended binder comprising a low surface energy polycarbonate and a film forming polymer. Although the next layer or next plurality of layers may have the same charge transport compound and binder polymer content, but generally the weight ratio of low surface energy polymer to film forming polymer increases as the layer rises towards the surface layer (40T and 40L, respectively) of the imaging member. This imparts the greatest lubricity to the imaging member surface. In other words, the weight ratio of charge transport compound to polymer (both low surface energy polycarbonate and film forming polymer) may decrease stepwise in each layer as the layer rises towards the surface of the imaging member, so that the lowest weight ratio is present in the outermost exposed layer. For example, the first layer 40F of FIG. 3 comprises a film forming polymer and charge transport compound, but no low surface energy polymer. The intermediate plurality of layers 40P comprise charge transport compound and a polymer blend (comprising of low surface energy polycarbonate and film forming polymer), wherein the weight percent of low surface energy polycarbonate in each layer, from lower to upper, would stepwise increase from about 10 to about 70 weight percent based on the total weight of the polymer blend for each layer, while the weight percent of film forming polymer is being reduced in each layer; that means the weight percent of the low surface energy polycarbonate increases in each upward layer. In the outermost exposed layer 40L, the polymer blend would comprise from about 70 to about 95 weight percent low surface energy polycarbonate. The outermost charge transport layer (40T and 40L in FIGS. 2 and 3, respectively) may also comprise a polymer blended binder of low surface energy polycarbonate and film forming polymer plus charge transport compound; nonetheless 40T and 40L may however be of binary composition, comprising of only the low surface energy polycarbonate and the charge transport compound without film forming polymer, to impart lowest surface energy and greatest surface lubricity.

It is very important that the low surface energy polycarbonate, film forming polymer, and charge transport compound are readily soluble in a common solvent suitable for use in the manufacturing coating solution preparation, such as methylene chloride, chlorobenzene, or some other convenient organic solvent. Generally, they are mixed together to form a coating solution. A typical solution has a 50:50 weight ratio of polymers to charge transport compound dissolved in a solvent to achieve 15 weight percent solids, based on the total weight of the coating solution.

The viscosity of the coating solution is preferred to be in the range from about 20 to about 900 centipoise (cp) when the solution is prepared to contain 15 weight percent solids. Although the viscosity of this 15 weight percent solution depends on the molecular weight of the polymers, but it can also conveniently be adjusted by either changing the concentration of polymers dissolved in the solution or using another solvent.

Any suitable technique may be used to mix and apply the CTL coating solution onto the charge generating layer. Generally, the components of the CTL are mixed into an organic solvent. Typical solvents comprise methylene chloride, toluene, tetrahydrofuran, and the like. Typical application techniques include extrusion die coating, spraying, roll coating, wire wound rod coating, and the like. Drying of the coating solution may be effected by any suitable conventional technique such as oven drying, infra red radiation drying, air drying and the like. When the CTL comprises multiple layers, each layer is solution coated, then completely dried at elevated temperatures prior to the application of the next layer. This procedure is repeated for each layer to produce the CTL.

The CTL may also contain a light shock resisting or reducing agent of from about 1 to about 6 wt-%. Such light shock resisting agents include 3,3′,5,5′-tetra(t-butyl)-4,4′-diphenoquinone (DPQ); 5,6,11,12-tetraphenyl naphthacene (Rubrene); 2,2′-[cyclohexylidenebis[(2-methyl-4,1-phenylene)azo]]bis[4-cyclohexyl-(9Cl)]; perinones; perylenes; and dibromo anthanthrone (DBA). The CTL may further be reinforced to contain organic (such as polytetrafluoroethylene-PTFE) or inorganic (selected from the group consisting of silica, metal oxides, metal carbonate, metal silicates, and mixtures thereof) particulate dispersions to improve wear resistance. One suitable particulate dispersion is described in U.S. Pat. No. 6,326,111, which is hereby incorporated by reference in its entirety.

In embodiments where the CTL comprises multiple layers, the specific material selected for each component of the layer may be independently selected for each layer. Typically, the same material is selected for each component of each layer and only the amount of the components is varied between layers. However, in some embodiments the outermost exposed layer (40T in FIGS. 2 and 40L in FIG. 3) comprises components different from that of the other layers. For example, in one embodiment according to FIG. 3, layers 40F and 40P do not have a particulate dispersion, but layer 40L does.

In general, the ratio of the thickness of the CTL to the charge generating layer is maintained from about 2:1 to about 200:1 and in some instances as great as about 400:1. However, the CTL is generally from about 5 micrometers to about 100 micrometers thick. Thicknesses outside this range can also be used provided that there are no adverse effects.

In embodiments where the CTL comprises multiple layers, the CTL may have a total of from about 2 to about 15 discreet layers, or from about 2 to about 7 layers, or from about 2 to about 3 layers. In other words, with reference to FIG. 3, the CTL may have a total of from 1 to about 13 intermediate layers. With reference to FIG. 3, the first or bottom charge transport layer 40F may be from about 5 to about 10 micrometers thick. Although the thickness of the first charge transport layer 40F may be the same as the collective or total thickness of the intermediate charge transport layers 40P, it is usually different. While the thickness of each of the intermediate charge transport layers 40P as well as the top layer 40L may be different, they are usually the same and range from about 0.5 to about 7 micrometers. Generally, the total thickness of a CTL having dual or multiple layers ranges from about 10 to about 110 micrometers.

In an electrographic imaging member, the dielectric layer of this disclosure overlying the conductive layer of a substrate may be used to replace all the active photoconductive layers. Any suitable, conventional, flexible, electrically insulating, thermoplastic dielectric polymer matrix material formulated with the low surface energy polymer of the preceding description may be used for the dielectric layer of the electrographic imaging member. If curl control is required, the flexible electrographic imaging member belts may also be added with an ACBC to provide belt flatness.

The prepared flexible electrophotographic imaging member belt, having the low surface energy and slippery surface according to the present disclosure, may then be employed in any suitable and conventional electrophotographic imaging process which utilizes uniform charging prior to imagewise exposure to activating electromagnetic radiation. When the imaging surface of an electrophotographic member is uniformly charged with an electrostatic charge and imagewise exposed to activating electromagnetic radiation, conventional positive or reversal development techniques may be employed to form a marking material image on the imaging surface of the electrophotographic imaging member of this disclosure. Thus, by applying a suitable electrical bias and selecting toner having the appropriate polarity of electrical charge, one may form a toner image in the charged areas or discharged areas on the imaging surface of the electrophotographic member of the present disclosure.

The development of the present disclosure will further be illustrated in the following non-limiting working examples. The examples set forth hereinbelow are illustrative of different compositions and conditions that can be used in practicing the present embodiments. All proportions are by weight unless otherwise indicated. It will be apparent, however, that the innovative description can be practiced with many types of compositions and can have many different uses in accordance with the disclosures above and as pointed out hereinafter.

### EXAMPLES

### Example of Coating Layer Preparation

Two low surface energy bisphenol A polycarbonate coating solutions were prepared in the lab for coating layer quality evaluation.

The first coating solution was prepared by dissolving the a pre-determined amount of a low surface energy polycarbonate LEXAN EXL1414T in methylene chloride solvent to give a 15 weight percent solid coating solution. The second coating was also prepared in the exact same procedures to give a 15 weight percent solid coating solution that contained a novel low surface energy bisphenol A polycarbonate LEXAN EXL 1463C.

The LEXAN EXL 1414T and EXL 1463C, are A-B di-block copolymer commercially available from Sabic Plastics; both have a molecular weight of about 25,000 and also have exact same molecular structure as represented by Formula (1) below:

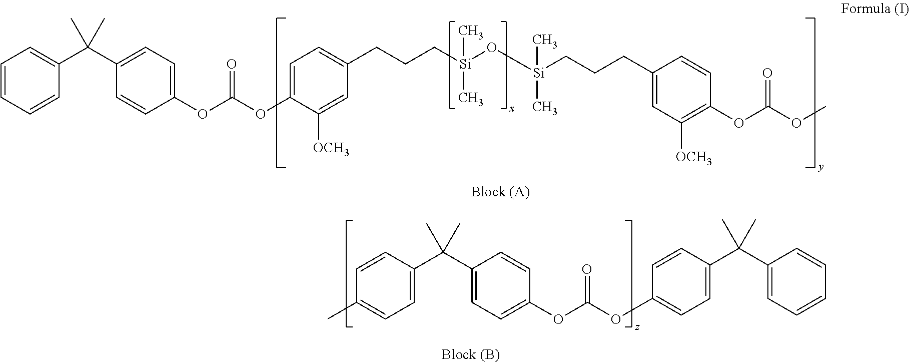

Even though both EXL1414T and EXL1463C do contain exact same 6 weight percent block (A) in each polymer backbone, based on the molecular weight of the low surface energy bisphenol A polycarbonate, as available from Sabic Plastics, nonetheless EXL1463C is an improved product over EXL1414T. The EXL1463C is designed with the intention to include one distinctively different feature apart from the EXL1414T through the reduction of the chain length of low surface energy polydimethyl siloxane (PDMS) repeat unit in block (A) segment of the polymer; that is by making the x value of 26 in the EXL 1463C, the PDMS repeating unit present in this low surface energy polycarbonate is, by comparison, a shorter chain of only about half the x value 50 in the EXL 1414T. Therefore from theoretical point of view, cutting the PDMS chain length to half in the EXL1463C should be the key to negate/offset the refractive index mismatch impact between the PDMS units and the polycarbonate main chain to thereby eliminate the light scattering effect (as observed in the EXL1414T layer) and give optically clear EXL 14163C coating layer. To establish the theoretical verification/assurance, experimental demonstration was then carried out as follows.

The two prepared coating solutions were each applied over a glass plate, using a 5 mil-gap draw bar, by following the standard hand coating procedure. The wet coating of each solution was dried at 120° C. in an air circulating oven for 2 minutes to give a 25 micrometer thickness dried layer. By naked eyes examination, the dried coating layer thus obtained for the EXL1463C was optically clear, whereas that of the EXL1414T counterpart was notably hazy. The observed haziness in the EXL1414T coating layer was due to the fact of refractive index mismatch between the PDMS units in the polycarbonate main chain to cause light scattering problem. Therefore, the shortening of PDMS chain length, designed to have less repeating units in the low surface energy EXL1463C polycarbonate, the light scattering was then effectively eliminated to give optically clear coating layer.

### Control Example

A flexible electrophotographic imaging member web was prepared by providing a 0.02 micrometer thick titanium layer coated substrate of a biaxially oriented polyethylene naphthalate substrate (PEN, available as KADALEX from DuPont Teijin Films.) having a thickness of 3.5 mils (89 micrometers). The titanized KADALEX substrate was extrusion coated with a blocking layer solution containing a mixture of 6.5 grams of gamma aminopropyltriethoxy silane, 39.4 grams of distilled water, 2.08 grams of acetic acid, 752.2 grams of 200 proof denatured alcohol and 200 grams of heptane. This wet coating layer was then allowed to dry for 5 minutes at 135° C. in a forced air oven to remove the solvents from the coating and effect the formation of a crosslinked silane blocking layer. The resulting blocking layer had an average dry thickness of 0.04 micrometer as measured with an ellipsometer.

An adhesive interface layer was then applied by extrusion coating to the blocking layer with a coating solution containing 0.16 percent by weight of ARDEL polyarylate, having a weight average molecular weight of about 54,000, available from Toyota Hsushu, Inc., based on the total weight of the solution in an 8:1:1 weight ratio of tetrahydrofuran/monochloro-benzene/methylene chloride solvent mixture. The adhesive interface layer was allowed to dry for 1 minute at 125° C. in a forced air oven. The resulting adhesive interface layer had a dry thickness of about 0.02 micrometer.

The adhesive interface layer was thereafter coated over with a charge generating layer. The charge generating layer dispersion was prepared by adding 0.45 gram of IUPILON 200, a polycarbonate of poly(4,4′-diphenyl)-1,1′-cyclohexane carbonate (PC-z 200, available from Mitsubishi Gas Chemical Corporation), and 50 milliliters of tetrahydrofuran into a 4 ounce glass bottle. 2.4 grams of hydroxygallium phthalocyanine Type V and 300 grams of ⅛ inch (3.2 millimeters) diameter stainless steel shot were added to the solution. This mixture was then placed on a ball mill for about 20 to about 24 hours. Subsequently, 2.25 grams of poly(4,4′-diphenyl-1,1′-cyclohexane carbonate) having a weight average molecular weight of 20,000 (PC-z 200) were dissolved in 46.1 grams of tetrahydrofuran, then added to the hydroxygallium phthalocyanine slurry. This slurry was then placed on a shaker for 10 minutes. The resulting slurry was thereafter coated onto the adhesive interface by extrusion application process to form a layer having a wet thickness of 0.25 mil. However, a strip of about 10 millimeters wide along one edge of the substrate web stock bearing the blocking layer and the adhesive layer was deliberately left uncoated by the charge generating layer to facilitate adequate electrical contact by a ground strip layer to be applied later. This charge generating layer comprised of poly(4,4′-diphenyl)-1,1′-cyclohexane carbonate, tetrahydrofuran and hydroxygallium phthalocyanine was dried at 125° C. for 2 minutes in a forced air oven to form a dry charge generating layer having a thickness of 0.4 micrometers.

This coated web stock was simultaneously coated over with a charge transport layer (CTL) and a ground strip layer by co-extrusion of the coating materials. The CTL was prepared by introducing into an amber glass bottle in a weight ratio of 1:1 (or 50 weight percent of each) of a bisphenol A polycarbonate thermoplastic (FPC 0170, having a molecular weight of about 120,000 and commercially available from Mitsubishi Chemicals) and a charge transport compound of N,N′-diphenyl-N,N′-bis(3-methylphenyl)-1,1′-biphenyl-4,4′-diamine.

The resulting mixture was dissolved to give 15 percent by weight solid in methylene chloride. This solution was applied on the charge generating layer by extrusion to form a coating which upon drying in a forced air oven gave a dry CTL 29 micrometers thick comprising 50:50 weight ratio of diamine transport charge transport compound to FPC0170 bisphenol A polycarbonate binder. The imaging member web, at this point if unrestrained, would curl upwardly into a 1½-inch tube.

The strip, about 10 millimeters wide, of the adhesive layer left uncoated by the charge generator layer, was coated with a ground strip layer during the co-extrusion process. The ground strip layer coating mixture was prepared by combining 23.81 grams of polycarbonate resin (FPC 0170, available from Mitsubishi Chemicals) having 7.87 percent by total weight solids and 332 grams of methylene chloride in a carboy container. The container was covered tightly and placed on a roll mill for about 24 hours until the polycarbonate was dissolved in the methylene chloride. The resulting solution was mixed for 15-30 minutes with about 93.89 grams of graphite dispersion (12.3 percent by weight solids) of 9.41 parts by weight of graphite, 2.87 parts by weight of ethyl cellulose and 87.7 parts by weight of solvent (Acheson Graphite dispersion RW22790, available from Acheson Colloids Company) with the aid of a high shear blade dispersed in a water cooled, jacketed container to prevent the dispersion from overheating and losing solvent. The resulting dispersion was then filtered and the viscosity was adjusted with the aid of methylene chloride. This ground strip layer coating mixture was then applied, by co-extrusion with the CTL, to the electrophotographic imaging member web to form an electrically conductive ground strip layer having a dried thickness of about 19 micrometers.

The imaging member web stock containing all of the above layers was then passed through 125° C. in a forced air oven for 3 minutes to simultaneously dry both the CTL and the ground strip.

An anti-curl coating was prepared by combining 88.2 grams of FPC0170 bisphenol A polycarbonate resin, 7.12 grams VITEL PE-200 copolyester (available from Goodyear Tire and Rubber Company) and 1,071 grams of methylene chloride in a carboy container to form a coating solution containing 8.9 percent solids. The container was covered tightly and placed on a roll mill for about 24 hours until the polycarbonate and polyester were dissolved in the methylene chloride to form the anti-curl back coating solution. The anti-curl back coating solution was then applied to the rear surface (side opposite the charge generating layer and CTL) of the electrophotographic imaging member web by extrusion coating and dried to a maximum temperature of 125° C. in a forced air oven for 3 minutes to produce a dried anti-curl back layer having a thickness of 17 micrometers and flattening the imaging member.

The flexible imaging member thus obtained was identified as 29953-81-1 and to be used to serve as a control.

### Comparative Example

Three prior art flexible electrophotographic imaging member webs were fabricated using the same materials and the same process as that described in Control Example, except that the formulation of each CTL was altered and modified with a prior art low surface energy polymer incorporation. In brief, the FPC 0170 bisphenol A polycarbonate binder in the CTL was partially replaced with the prior art low surface energy polycarbonate LEXAN EXL1414-T, therefore, the binder of each CTL became a binary polymer blend of EXL1414T and PFC bisphenol A polycarbonate.

The prepared imaging members having the resulting CTLs formed from binder of these three polymer blends were identified as 29953-81-2, 29953-81-3, and 29953-81-4 which comprising 20, 25, and 33.3 weight percent, respectively of LEXAN EXL 1414-T, based only on the combined weight of the polymer blend of EXL1414T and FPC 0170 bisphenol A polycarbonate. The prior art imaging members thus obtained were to be used for comparison against each respective imaging member prepared according to the methodology of this disclosure.

### Disclosure Example

Three flexible electrophotographic imaging member webs, comprised CTLs of present disclosure, were then likewise fabricated using the same materials and the same process as that described in Control Example, but with the exception that the CTL is reformulated to include a low surface energy polycarbonate. In essence, the FPC 0170 bisphenol A polycarbonate binder in the CTL was partially replaced with each respective amount of the novel low surface energy polycarbonate LEXAN EXL1463C of present disclosure to form a binary polymer blended binder.

The resulting slippery CTLs in the imaging members, as prepared according to the present disclosure, had polymer blended binders comprising 20, 25, and 33.3 weight percent, respectively, of LEXAN EXL 1463C, based only on the combined weight of the polymer blend of EXL1414T and FPC 0170 bisphenol A polycarbonate.

Physical/Mechanical/Photoelectrical Properties Assessment

The flexible electrophotographic imaging members of the Control Example, Demonstration Example, and the Disclosure Example were first determined for physical and mechanical properties, such as CTL surface energy, contact friction, and abhesiveness. The determinations were carried out by liquid wetting/contact angle measurement method for surface energy; contact friction against a polyurethane cleaning blade's sliding action for lubricity/slipperiness, and 180° 3M adhesive tape peel-off strength for propensity of surface filming development. The results obtained are tabulated in the Table 1 below:

TABLE 1

| | | | 180° 3M |
|---|---|---|---|
| | | Coefficient of | Tape Peel |
| Types of CTL | Surface Energy | Friction | Strength |
| Formulation | (dynes/cm) | (against blade) | (gms/cm) |
| CTL Control | 40 | 2.48 | 240 |
| 20% (1463C/1414T) | 25/28 | 0.78/0.81 | 31/37 |
| 25% (1463C/1414T) | 23/28 | 0.76/0.81 | 30/37 |
| 33.3% (1463C/1414T) | 20/26 | 0.75/0.80 | 28/36 |

The results listed in the above table indicate that imaging members of Disclosure Example, comprising CTLs reformulated to incorporate the novel low surface energy LEXAN EXL1363C polycarbonate, had provided overall physical/mechanical properties improvement over those CTLs using the LEXAN EXL 1414-T polycarbonate in prior art Comparative Example. In summary, the resulting CTLs comprised of EXL1463C polycarbonate incorporation had low surface energy, low coefficient of friction, and good surface release. Therefore, the surface abhesiveness (opposite to adhesiveness), as seen in reduction in tape peel strength, is a positively indication to insure that the CTL should have: low propensity of surface filming development, increased abrasion/wear resistance, improved the efficiency of toner image transfer to paper, and eased the cleaning blade action for dirt/debris removal from the imaging member belt surface during xerographic imaging processes. Additionally, the CTLs in the imaging members of Disclosure Example adhered well to the charge generating layer and gave about equivalent bonding strength as that seen in the CTL of the STD Control Example.

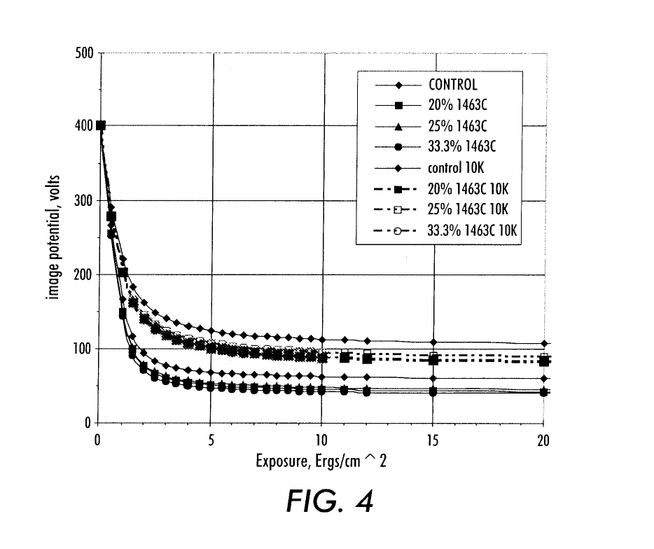

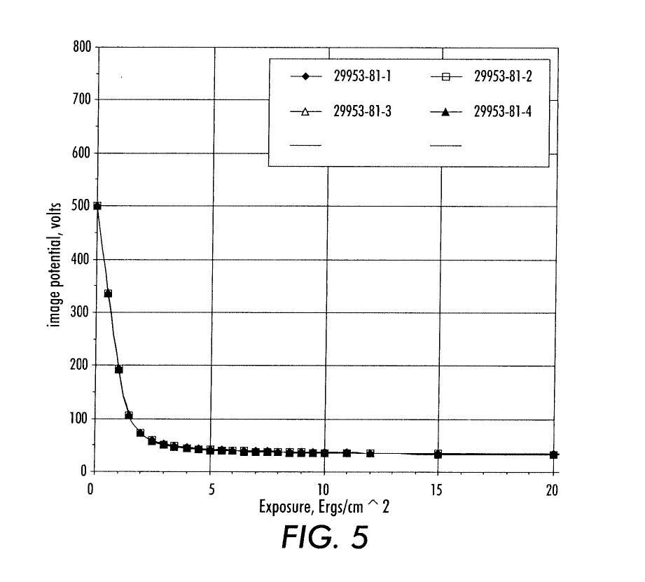

All the above imaging members were further assessed for each respective photo-electrical function. Photo-electrical property assessment was conducted, using a 4000 scanner, to assure that the overall photoelectrical integrity of each of the disclosure imaging members was not altered due to the incorporation/replacement of the film forming FPC polymer binder in the CTL with a low surface energy polycarbonate. As shown in the photo-induced dark decay curves in FIGS. 4 and 5, both LEXAN EXL1463C and LEXAN EXL1414T presence in the imaging member CTLs did not cause notable deleterious impact to the photo-electrical functions. And by comparison, CTLs comprising LEXAN EXL1463C did give improved properties than those of LEXAN EXL 1414T prior art.

In conclusion, the overall results obtained in the present disclosure, imaging members having slippery CTLs re-formulated to comprise LEXAN EXL1463C low surface energy polycarbonate to give slippery surface had provided greater physical/mechanical/photoelectrical improvements and out-performed over the standard control and LEXAN EXL1414T CTL counterparts in all types of testing. For example, shorter PDMS chain inserted in the bisphenol A polycarbonate backbone of EXL1463C were more evenly distributed in the polymer chain than those of the EXL1414T to give excellent optical clarity coating layer, while solution coated film of EXL1414T had some degree of haziness due the light scattering effect of the larger PDMS segments. Thus, the photoelectrical properties of imaging member prepared to comprise EXL1463C incorporation in the CTL had improvement outperformed than those of standard imaging member control as well as the imaging members prepared to have EXL1414T in the CTL.

What is claimed is:

1. A flexible imaging member comprising:
a flexible substrate;
a charge generating layer disposed on the substrate; and
at least one charge transport layer disposed on the charge generating layer, wherein the charge transport layer comprises a charge transport component molecularly dispersed in a low surface energy polycarbonate binder, the polymer binder being an A-B di-block copolymer comprising two segmental blocks, the first segment block (A) being 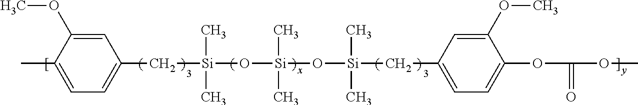
wherein x is 10 to 40, y is 1 to 15, and the second segment block (B) being selected from the group consisting of 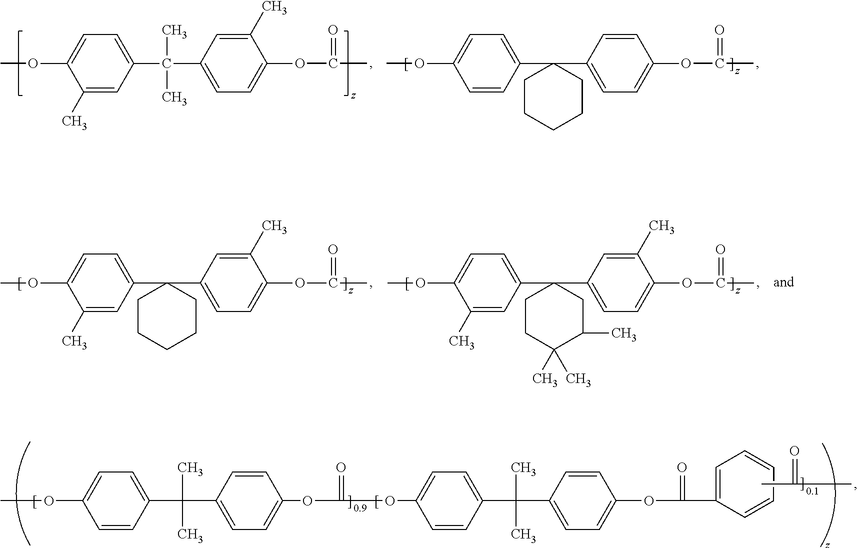
wherein z is 50 to 400.

2. The flexible imaging member of claim 1, wherein the low surface energy polycarbonate polymer is 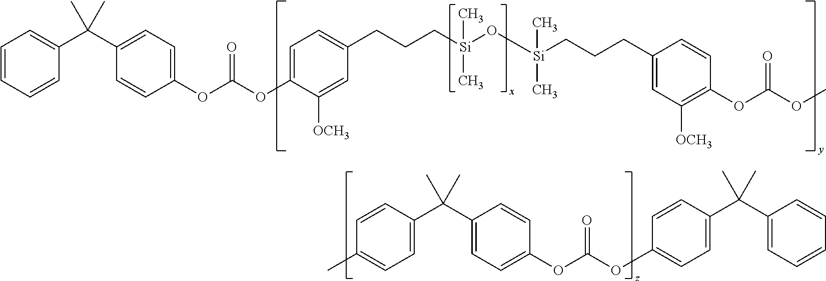
wherein x is 10 to 40, y is 1 to 15, and z is 50 to 400.

3. The flexible imaging member of claim 2, wherein x is 25.

4. The flexible imaging member of claim 1, wherein the low surface energy polycarbonate polymer exhibits little or no light scattering effect to render optical clarity.

5. The flexible imaging member of claim 1, wherein the low surface energy polycarbonate binder has a molecular weight of from about 15,000 to about 130,000.

6. The flexible imaging member of claim 1, wherein the low surface energy polycarbonate binder is present in the charge transport layer in an amount of from about 40 to about 75 percent by weight of the total weight of the charge transport layer.

7. The flexible imaging member of claim 6, wherein the low surface energy polycarbonate binder is mixed with a film forming polycarbonate polymer to form a polymer-blend binder in which the low surface energy polycarbonate is present in the charge transport layer in an amount of from about 5 to about 25 percent by weight of the total weight of the charge transport layer.

8. The flexible imaging member of claim 1, wherein the charge transport layer is a single layer that includes an organic particle dispersion and inorganic fillers selected from the group consisting of polytetrafluoroethylene (PTFE), silica, metal oxides, metal carbonate, metal silicates, and mixtures thereof.

9. The flexible imaging member of claim 1, wherein the charge transport layer further includes a light shock resisting or reducing agent present in an amount of from about 1 to about 6 percent by weight of the total weight of the charge transport layer.

10. The flexible imaging member of claim 1, wherein the charge transport layer is a dual-layer including a bottom charge transport layer and a top exposed charge transport layer disposed on the bottom charge transport layer, and further wherein the top exposed charge transport layer comprises the low surface energy polycarbonate or a blended binder of the low surface energy polycarbonate and a film forming polycarbonate to provide surface slipperiness.

11. The flexible imaging member of claim 1, wherein the charge transport layer is a triple-layer including a bottom charge transport layer, a middle charge transport layer disposed on the bottom charge transport layer, and a top exposed charge transport layer disposed on the middle charge transport layer, and further wherein the top exposed charge transport layer comprises the low surface energy polycarbonate or a blended binder of the low surface energy polycarbonate and a film forming polycarbonate to provide surface slipperiness.

12. The flexible imaging member of claim 1, wherein the charge transport layer comprises multiple layers including a bottom charge transport layer, a plurality of middle charge transport layers disposed on the bottom charge transport layer, and a top exposed charge transport layer disposed on the plurality of middle charge transport layers, and further wherein the top exposed charge transport layer comprises the low surface energy polycarbonate or a blended binder of the low surface energy polycarbonate and a film forming polycarbonate to provide surface slipperiness.

13. The flexible imaging member of claim 12, wherein the amount of charge transport compound present in the charge transport layers decreases from the bottom charge transport layer to the top exposed charge transport layer.

14. The flexible imaging member of claim 1, wherein a surface energy of the charge transport layer is from about 20 to about 25 dynes/cm.

15. The flexible imaging member of claim 1, wherein a coefficient of friction of the charge transport layer against the sliding action of a polyurethane cleaning blade is from about 0.75 to about 0.78.

16. The flexible imaging member of claim 1, wherein a 180° tape peel-off strength from the surface of the charge transport layer is from about 28 to about 31 gms/cm.

17. A flexible imaging member comprising:
a flexible substrate;
a charge generating layer disposed on the substrate;
a bottom charge transport layer disposed on the charge generating layer; and
a top exposed charge transport layer disposed on the bottom charge transport layer, wherein the top exposed charge transport layer comprises a charge transport component molecularly dispersed in a low surface energy polycarbonate binder, the polymer binder being formed from a modified Bisphenol A polycarbonate poly(4,4′-isopropylidene diphenyl carbonate) having from about 4 percent to about 8 percent by weight of polydimethyl siloxane containing segments present in the low surface energy polycarbonate back bone and having the following molecular formula: 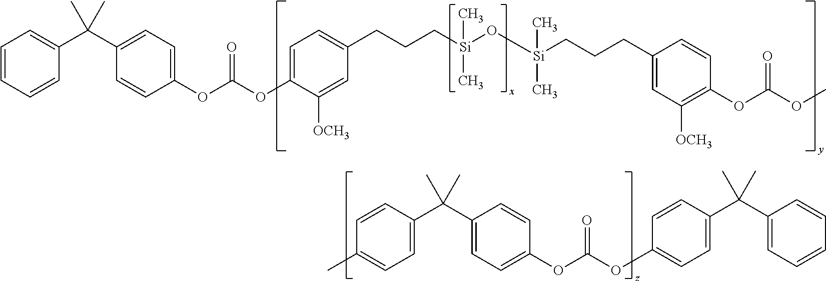
wherein x is 10 to 40, y is 1 to 15, and z is 50 to 400.

18. The flexible imaging member of claim 17, wherein the bottom and the top exposed charge transport layers are of the same thickness.

19. The flexible imaging member of claim 17, wherein the polymer binder in the dual charge transport layers is a polymer blend comprising the low surface energy polycarbonate and film forming polycarbonate in which more amount of the low surface energy polycarbonate is present in the top exposed layer.

20. The flexible imaging member of claim 17, wherein an amount of the charge transport component present in the bottom charge transport layer is greater than that present in the top exposed charge transport layer.

21. An image forming apparatus for forming images on a recording medium comprising:
a) a flexible imaging member having a charge retentive-surface for receiving an electrostatic latent image thereon, wherein the flexible imaging member comprises
a flexible substrate;
a charge generating layer disposed on the substrate; and
at least one charge transport layer disposed on the charge generating layer, wherein the charge transport layer comprises a charge transport component molecularly dispersed in a low surface energy polycarbonate binder, the polymer binder being an A-B di-block copolymer comprising two segmental blocks, the first segment block (A) being 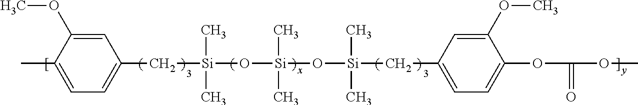
wherein x is 10 to 40, y is 1 to 15, and the second segment block (B) being selected from the group consisting of 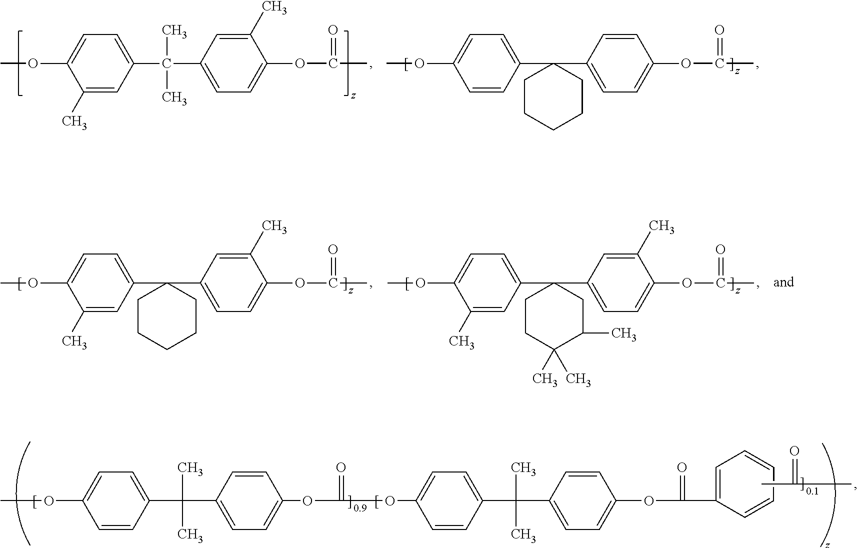
wherein z is 50 to 400;
b) a development component for applying a developer material to the charge-retentive surface to develop the electrostatic latent image to form a developed image on the charge-retentive surface;
c) a transfer component for transferring the developed image from the charge-retentive surface to a copy substrate; and
d) a fusing component for fusing the developed image to the copy substrate.
